(19) United States
(12) Patent Application Publication
(10) Pub. No.: US 2008/0073592 A1
(43) Pub. Date: Mar. 27, 2008

(54) Reflective optical illumination collector

(76) Inventors: Eric M. Panning, Hillsboro, OR (US); Michael Goldstein, Ridgefield, CT (US); Ranju D. Venables, Fremont, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/490,925

(22) Filed: Jul. 21, 2006

(51) Int. Cl. G01J 1/00

(52) U.S. Cl. 250/495.1

(57) ABSTRACT

A reflective optical illumination collector is described. In one example, the collector has a ring to collect light from a light source within a range of incident angles and to reflect the light off an inner surface of the ring to a target image of the collector. A plurality of rings concentric to the first ring may also be used. Each ring collects light from the light source within a range of incident angles and reflects the light off an inner surface of the respective ring to the target image of the collector.

### BACKGROUND

1. Field

The present description relates to the field of optical collectors for EUV photolithography, and in particular, to a collector using an elliptical reflective surface to provide collection in a single reflection.

2. Related Art

Photolithography is used in the fabrication of semiconductor, micromechanical and microelectronic devices. In photolithography, a light sensitive material, called a “photoresist”, coats a wafer substrate. The photoresist is then exposed to light reflected from or transmitted through a mask to reproduce an image of the mask. When the wafer is illuminated through the mask, the photoresist undergoes chemical reactions and is then developed to produce a replicated pattern of the mask on the wafer.

Extreme Ultraviolet (EUV) light has been proposed for use in future photolithography processing. EUV light may be produced from a plasma at sufficient temperature to radiate in the desired wavelength, for example, in a range of approximately 11 nm to 15 nm. The plasma may be created in a vacuum chamber, typically by driving a pulsed electrical discharge through the target material or by focusing a pulsed laser beam onto the target material. The light produced by the plasma is then collected by nearby mirrors, multilayer Si/Mo mirrors are proposed, and reflected off the mask.

In order to direct the EUV light to a mask to expose the photoresist, it must be collected from the light source. Current collectors are expensive and collect only a small portion of the light produced by the source. Any light that is absorbed by the collector creates heat and may tend to damage the collector. In addition, a less efficient collector requires a brighter source which also produces unnecessary heat among other problems.

The Wolter collector has been adapted from existing x-ray telescopes. It uses a long format that is suitable for imaging distant light sources such as stars. As applied to industrial equipment and very bright nearby sources, however, a Wolter collector tends to be expensive to design and build and have a limited useful life. It is also difficult to cool due to the length of the collector shells. Finally, the two bounce optics lose light at each reflection and limit the angles at which incoming light may be collected.

### BRIEF DESCRIPTION OF THE DRAWINGS

Embodiments of the present invention may be understood more fully from the detailed description given below and from the accompanying drawings of various embodiments of the invention. The drawings, however, should not be taken to be limiting, but are for explanation and understanding only.

FIG. 1 is a diagram of an optical collector assembly for photolithography according to an embodiment of the invention;

FIG. 2 is a ray trace diagram of the collector of FIG. 1 according to an embodiment of the invention;

FIG. 3 is a cross-sectional diagram of an elliptical cross-section of a single shell of the collector of FIG. 1, showing light collection from the source and focusing, according to an embodiment of the present invention;

FIG. 4 is a process flow diagram of producing an elliptical shell for the collector of FIG. 1 according to an embodiment of the present invention; and

FIG. 5 is a diagram of a semiconductor fabrication device suitable for application to the present invention.

### DETAILED DESCRIPTION

Elliptical mirrors may be designed and constructed to collect EUV with a single bounce, a high range of incident light angles and at low cost. The design is compact, potentially easy to cool, and collects a larger proportion of the light from an EUV source than many other designs. As many as fifteen or more elliptical shells may be used to collect light from different types of EUV sources. The shells are reflective and may be used in a vacuum environment to avoid absorption.

A fifteen shell elliptical collector is described below, however, the number of shells and their design may be modified to increase the efficiency of collection and to accommodate different EUV sources. Different materials may also be chosen to increase reflectivity as a function of angle and the lifetime of the collectors.

The described collector is particularly well-suited for discharge produced plasma (DPP) sources. However, it may be adapted to any of a variety of other extreme ultraviolet (EUV) and other light sources.

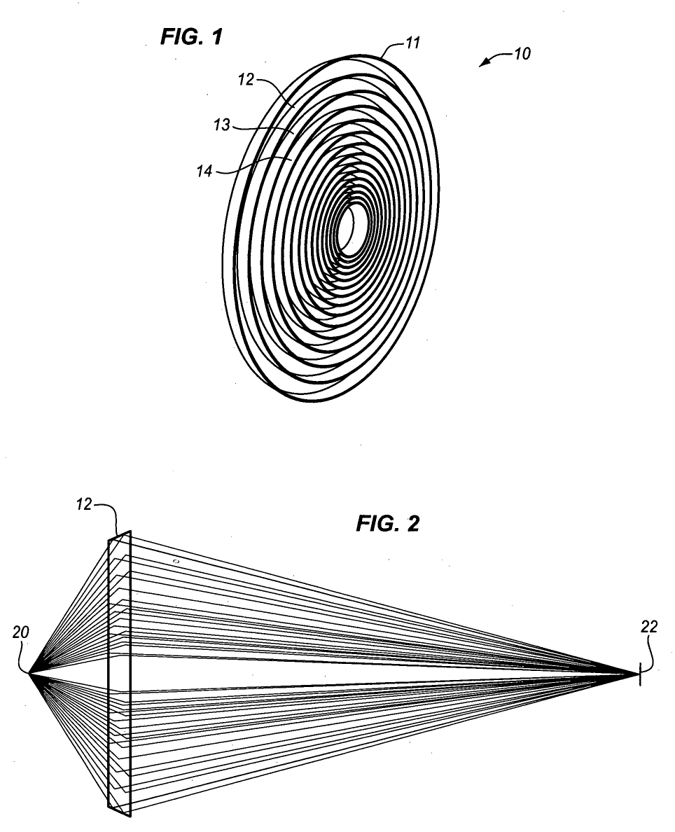

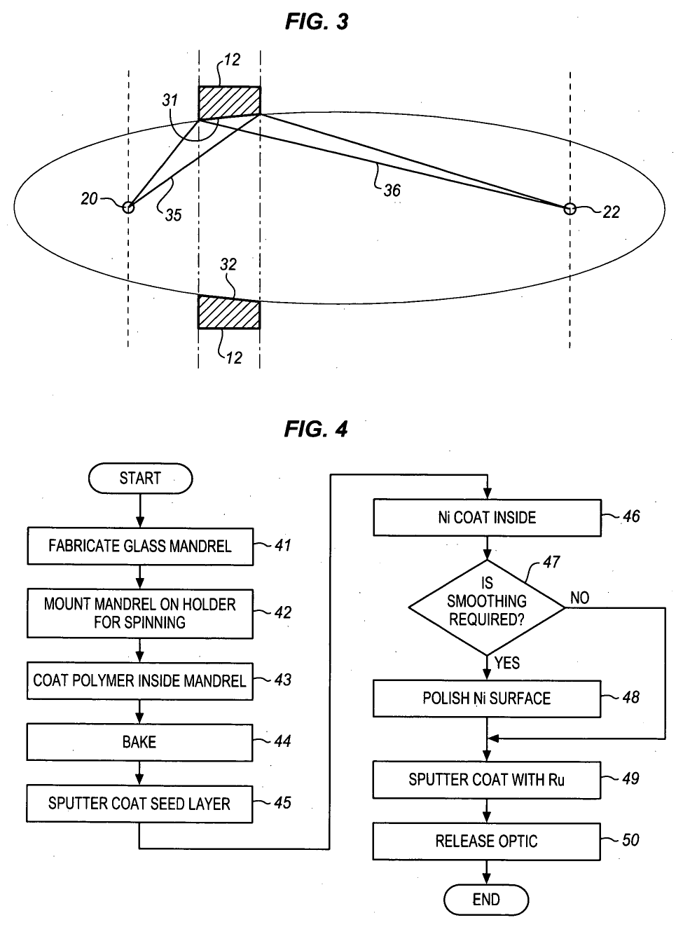

FIG. 1 shows an example of a fifteen ring elliptical collector 10 according to an embodiment of the invention. The collector has fifteen concentric or nested rings 11, 12, 13, 14 . . . Each ring is in the shape of a circle and is formed by a shell with an elliptical cross-section, as shown in FIG. 3. The illustrated collector has been simulated to have a collection efficiency of about 63%. The collection efficiency may be increased by increasing the number of shells.

FIG. 2 is a simulated ray trace diagram showing the collection of EUV light by the array of nested shells, the array of elliptical shells, including outer shell 12 collect the light from a light source 20 and bring it to a focus at a focus point 22. The light at the focus point may be imaged directly on the lithography mask or at relay optics that relay the light to the mask or to some other optical system. As can be seen from FIG. 2, a single reflection brings the light from the source to the focus point. Because the best EUV reflectors are still poor reflectors and still absorb a significant part of the light, reducing the number of reflections or bounces significantly improves the efficiency of the collector. This is particularly true for shallow reflection angles. For broader reflection angles, two bounces may offer advantages that overcome the light loss, however, the best design may depend on the particular reflector material, and other aspects of the optical design.

FIG. 3 is a diagram of a cross-section of an example elliptical shell 12 of the collector 10 of FIG. 1. The cross-sectional diagram shows two internal surfaces 31, 32 which are exposed to the EUV light. If, as shown in FIG. 1, the shells are circular, then these two surfaces are different locations on one continuous inner surface of the ring. FIG. 3 also shows an ellipse drawn with one focus 20 at the illumination source image plane and the other focus 22 at the focal point of the collector system. The outer surface of the ellipse defines the shape of the inner reflective surface 31, 32 of the shell. FIG. 3 further shows how the shell reflects a cone of light 35 from the source, to another cone of light 36 that converges at the focal point.

The cone of light represents a large solid angle. The reflectivity of, for example, a Ru coated elliptical shell may be greater than 60% for angles greater than 25°. For larger angles, multilayer coatings may be used on the elliptical shells. A five bi-layer multilayer mirror of SiC and Ru, each of thicknesses 13.8 nm and 9.9 nm respectively may provide reflectivity of greater than 60% for higher solid angles, such as 32° or more. Other reflective coatings may be used to optimize performance for still higher incident angles.

The elliptical surface of each shell may be based on an ellipse with a different height, but the same foci. This provides a different shape surface on each shell and the surface will be shaped specifically for the range of angles that are anticipated for that shell to reflect. The number of shells and their design may be adapted to suit different light sources and different types of reflectors.

Each shell is able to efficiently reflect light within a certain range of incident angles. The width of the shell will determine the range of incident angles that it will collect. Accordingly, the width of each shell may be selected for the angles at which it works best, or at which it works well. For a Ru coated shell, incident angles of from 0° (tangential) to about 15° show good reflectivity and the reflectivity may still be usable at angles as high as 25° or 32°. Ray tracings such as that of FIG. 3 may be used to determine the optimum width of a collector shell that will limit the incident angles to within the desired range.

Another design limitation is the thickness and the width of the shells. Each shell will block light that would otherwise reach a neighboring shell on either side. The amount of light blocked may be reduced by reducing the thickness of each shell (the vertical direction in FIG. 3) and also by reducing the width of each shell (the horizontal direction in FIG. 3). Blocked light may be eliminated by placing the shells farther apart. However, if the spacing is too great then some light may not hit a reflector shell and be lost. This will limit the number of shells that may be used in the collector. The thickness and width of each shell, then limits how close the shells may be placed to one another. Ideally the light that is intercepted by a neighboring shell is only light that is beyond the desired incident angle range of the shell from which the light was blocked.

Another design parameter is the range of incident angles from the light source that are to be intercepted. As shown in the example of FIG. 2, the collected light subtends an angle of about 120°. Any light produced beyond that angular range is lost or reflected by some device, internal to the light source. To collect a wider angular range of light, more shells may be used, while to collect a narrower angular range of light fewer shells may be used.

In one example, the collector uses fifteen shells, as mentioned above. The largest shell has a diameter of about 700 mm, while the smallest shell has a diameter of about 94 mm. Each shell is about 50.8 mm wide and about 1 mm thick. This appears to work well with a particular DPP light source that is about 0.5 mm high and wide and about 2 mm deep. However, for other light sources and other reflectors, other numbers of shells of other sizes may provide better results.

While the shells in the figures are shown as circular, this is related to the choice of light source and other optical elements in the photolithography system. The particular physical shape of the rings may be elliptical, oval, or elongated in more than one dimension in order to suit other light sources and to direct light to other types of optical elements.

The collectors may be fabricated in a variety of different ways. In one example, a glass shell may be used for the substrate or, in other words, as a mandrel. First a release layer is applied to the mandrel surface. Then a seed layer is applied over the release layer. A base layer is applied over the seed layer and a reflective coating is applied over the base coat. In one example, the release layer is a polymer, the seed layer is a metal, the base layer is another metal layer, and the reflective coating is Ru or a multilayer coating.

Depending on the particular choice of materials and intended application, one or more of these layers may not be necessary. The release layer may be avoided by using thermal expansion to release the reflector or by not releasing the reflector from the mandrel. The seed layer may be avoided by combining the seed layer and base layer into single layer or by using a conductive polymer as the release layer.

Considered in more detail, a polymer is sprayed onto the inside of the glass mandrel. This polymer is eventually used as the release layer. A seed layer of Au, Au—Pd. Ni, Cr, Pt, Ag reduction, or any of a variety of other seed materials may then be sputter coated, sprayed, deposited or electroplated over the polymer inside the glass mandrel. The deposited seed layer is then electroplated or electroformed with a base coat of Ni, Ni—Co, Ni—P, Cu or any of a variety of other materials individually or in any combination of two or more materials. The electroplated material may then be machined, or polished, or both to the desired surface roughness value, if necessary. Finally, the electroplated base coat material is sputter coated with Ru or other multilayer materials.

The optic is released from the mandrel by dissolving the polymer. This may be done with heat or with a chemical, such as acetone, or in a variety of other ways such as photodissolution. While the lifetime of the glass shell mandrel may be short in an EUV environment, this does not limit the lifetime of the collector when the final optic does not include the mandrel. Even if the glass mandrel were not released, the optical surface of the optic is opposite the surface of the glass mandrel. As a result, the glass would be at least partially protected. This would extend the lifetime of the glass in the EUV environment.

As an alternative, instead of applying the polymer release layer and the seed layer, the inside diameter of the mandrel may be directly electro-less plated with Ni or another metal. The electroplated material is machined or polished to the desired surface roughness values to minimize flare. The Ru or other multilayer mirror materials may be directly coated over the Ni. Another approach, would be to deposit a seed layer by spraying or physical vapor deposition, followed by electroplating with the material of choice. Finally the optic may be released by cooling. The cooling may be selected to exploit the vastly different coefficients of thermal expansion between the glass and the Ni metal. With either approach, for any specific shape and finish of the optics, the reflecting surfaces can be machined, polished or electro-polished easily without deforming the optic since the mandrel may be used to provide mechanical support until after the polishing is finished.

FIG. 4 shows one example of a process flow diagram for creating the elliptical shells. This begins with a glass mandrel. The mandrel may first be polished at block 41 and in one example, the glass mandrel is polished to a 5 nm RMS (Root Mean Square) roughness. Further with this approach it is also possible to reduce the cost of the mandrel by using a surface with marginal surface roughness. The initial roughness does not affect the performance of the final reflector because the final reflecting surface can be modified to meet atomic precision by machining, polishing, or both before applying the final reflective coat, an Ru or multilayer coating.

At block 42, the glass mandrel may be mounted on a holder, such as a self centering holder for spinning. At block 43, a polymer is then spin coated or spray coated inside of the mandrel. A variety of different polymers may be used. Polymers that can be thermally dissociated, or conductive polymers, or polymers that can be dissolved by exposure to light may be used. If a conductive polymer is used then the metal seed layer may not be needed. At block 44, the coated mandrel is baked.

At block 45, a seed coat layer, if needed, is applied, over the polymer. This may be done, for example, by sputtering. At block 46, the inside of the mandrel is coated with a Ni layer directly over the seed layer. This coating may be measured to quantify its roughness. Different techniques may be used including AFM (Atomic Force Microscopy) and interferometry. The surface smoothness is important as this may affect the reflectivity of the eventual reflector.

If at block 47, further smoothing is required, then at block 48, the surface may be polished. Electro-polishing, or in a lower volume fabrication, hand polishing may be applied to the Ni surface. The surface may be measured again, and the roughness quantified again by AFM and/or interferometry.

When the surface is sufficiently smooth, then at block 49, it may be sputter coated with Ru. Alternatively, multilayer mirrors may be fabricated on the inside of the optic and then the thickness and roughness may again be measured. If the surface is good, then at block 50, the optic may be released from the mandrel by dissolving the polymer. Before use, the optic may be tested for quality, including characterizing it at visible and EUV wavelengths.

As an alternative, instead of using a seed layer, the Ni may be applied directly to the polymer. This may result in better adhesion to the mandrel during the rest of the fabrication process. With a Ni seed layer, a Ni—Co or Ni—P layer may be electroplated onto the seed layer, instead of a straight Ni layer. As a further alternative, Cr or Pt may be used as the seed layer instead of Au. As a further alternative, a silver reduction may be sprayed on the interior to act as the seed layer.

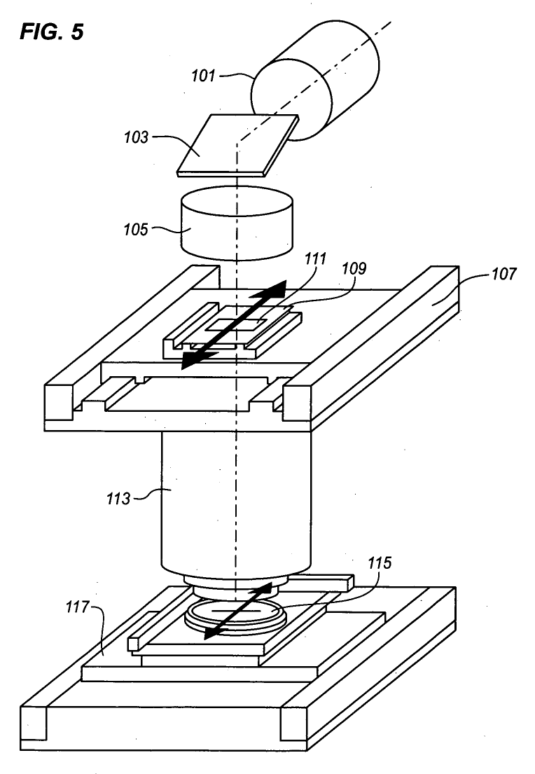

FIG. 5 shows a conventional architecture for a semiconductor fabrication machine, in this case, an optical photolithography machine, that may be used to hold a mask and expose a wafer using a collector as described above. The stepper may be enclosed in a sealed vacuum chamber (not shown) in which the pressure, temperature and environment may be precisely controlled. The stepper has an illumination system including a light source 101, such as a DPP chamber, and an optical collection system 105 such as that described above to focus the light on the wafer. A reticle scanning stage 107 carries a reticle 109 which holds the mask 111. The light from the lamp is transmitted onto the mask and the light transmitted through the mask is focused further by a projection optical system with, for example, a four-fold reduction of the mask pattern onto the wafer 115. While, the stepper of FIG. 5 is an example of a fabrication device that may benefit from embodiments of the present invention. Embodiments of the invention may also be applied to many other photolithography systems, including systems with reflective masks.

A lesser or more complex shell configuration, cross-sectional design, concentric arrangement, and production process may be used than those shown and described herein. Embodiments of the invention may be applied to different reflective materials and constructions. Optical elements may be added to the system for a variety of different reasons. Therefore, the configurations may vary from implementation to implementation depending upon numerous factors, such as price constraints, performance requirements, technological improvements, or other circumstances. Embodiments of the invention may also be applied to other types of photolithography systems that use different materials and devices than those shown and described herein.

In the description above, numerous specific details are set forth. However, it is understood that embodiments of the invention may be practiced without these specific details. For example, well-known equivalent materials may be substituted in place of those described herein, and similarly, well-known equivalent techniques may be substituted in place of the particular processing techniques disclosed. In other instances, well-known optical elements, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

What is claimed is:

1. An optical collector comprising:
a ring to collect light from a light source within a range of incident angles and to reflect the light off an inner surface of the ring to a target image of the collector.

2. The collector of claim 1, further comprising a plurality of rings concentric to the first ring, each ring collecting light from the light source within a range of incident angles and reflecting the light off an inner surface of the respective ring to the target image of the collector.

3. The collector of claim 1, wherein the inner surface is a portion of an ellipse.

4. The collector of claim 1, wherein the ring is circular.

5. The collector of claim 1, wherein the target image is a focal point.

6. The collector of claim 1, wherein the inner surface is coated with Ru.

7. An optical collector for EUV light comprising:
a plurality of reflective elements arranged to reflect light from the source to a target image of the collector in a single reflection.

8. The collector of claim 7, wherein the reflective elements have an elliptical reflective surface.

9. The collector of claim 7, wherein the reflective elements each reflect light emanating from the source at a discrete range of incident angles.

10. The collector of claim 7, wherein the reflective elements are arranged concentrically about a single center.

11. The collector of claim 7, wherein the reflective elements are each shaped as a circular ring with a different diameter, the rings being concentric.

12. A method comprising:
providing a circular mandrel having an elliptical cross-section;
coating the mandrel with a base layer;
coating the base layer with a reflective layer.

13. The method of claim 12, further comprising polishing and/or machining the reflective surface.

14. The method of claim 13, further comprising:
coating the mandrel with a release layer before coating the mandrel with the base layer; and
releasing the base layer from the mandrel after coating the base layer.

15. The method of claim 13, further comprising polishing the reflective layer before releasing the base layer.

16. The method of claim 13, wherein the release layer is a polymer layer.

17. The method of claim 16, further comprising baking the polymer layer and then coating the mandrel with a seed layer and wherein coating the mandrel with a base layer comprises coating the base layer over the seed layer.

18. The method of claim 12, wherein coating the base layer with the reflective layer comprises sputter coating a Ni base layer with Ru.

19. The method of claim 12, further comprising coating the mandrel with a seed layer before coating the mandrel with the base layer and wherein coating the mandrel with the base layer comprises electro-less plating the seed layer with nickel, and polishing the nickel layer.

20. The method of claim 12, wherein coating the base layer with a reflective layer comprises depositing alternating layers of Mo—Si to create an EUV reflective surface.
